(19) United States
(12) Patent Application Publication
(10) Pub. No.: US 2005/0084830 A1
(43) Pub. Date: Apr. 21, 2005

(54) Method of teaching a foreign language of a multi-user network requiring materials to be presented in audio and digital text format

(76) Inventor: Steven Joseph Kaufmann, West Vancouver (CA)

Correspondence Address: GRAFFITI PROMOTIONS, LLC, 827 WINDSOR ROAD, ARNOLD, MD, 21012, US

(21) Appl. No.: 11/005,042

(22) Filed: Dec. 6, 2004

Related U.S. Application Data
(63) Continuation of application No. 10/655,826, filed on Sep. 5, 2003.

(51) Int. Cl. G09B 19/08; G09B 5/00; G09B 19/06

(52) U.S. Cl. 434/169; 434/309

(57) ABSTRACT

Method for web based language learning that empowers self-directed learners by introducing measurement within an integrated system of context-based non-didactic learning. In another embodiment learning system of the present invention is designed to help people learn from audio and digital text. The learning system of the present invention is effective in any learning situation where language is the main medium of instruction because the learning system of the present invention requires material to be presented in audio and digital text format. The combination of listening, reading and word and phrase review increases retention and confidence. By systematically learning new words and phrases in context, not only are language skills improved, but the ability to understand new concepts is enhanced. Reinforcement from multiple sources speeds up and enhances the learning process. The student has the instant ability to test himself on all key points. This is a kind of electronic note-taking system, which can tie all notes together and present them for quick review. Once the student understands the concepts he can listen to the lectures again or to recorded text material to reinforce comprehension.

### FEDERALLY SPONSORED RESEARCH

Not Applicable

### SEQUENCE LISTING OR PROGRAM

Not Applicable

### CROSS-REFERENCE TO RELATED APPLICATIONS

This application is a continuation in part of U.S. patent application Ser. No. 10/655,826, entitled “Method of Teaching a Foreign Language to a Student Providing Measurement in a Context Based Learning System,” filed on Sep. 5, 2004.

### TECHNICAL FIELD OF INVENTION

The present invention relates generally to a self directed foreign language learning aid and method of learning, and in particular an aid and method in which the learner chooses content of interest for listening and reading, storage, and analysis of the learners words and lexical phrases utilizing personalized databases through interaction with a web based computer system. The learner can also interact with other learners and native speaking coaches.

### BACKGROUND OF THE INVENTION

Increased globalization and technological advances have increased the demands for fluency and literacy in a variety of languages. The desirability and benefits of being multi-lingual have never been greater, creating an overwhelming interest in foreign language learning aids, techniques, and methods.

Traditional learning aids typically include classroom instruction, flash cards, audio cassettes, CDs, magazine, and books. Each of theses traditional teaching aids has their own advantages and disadvantages. For example, classroom instruction provides instant feedback and promotes interaction among learners, but requires students to study pre-determined topics on a set schedule and pace. While the other aids such as flash cards, magazines, books are relatively inexpensive they do not provide any degree of audible feedback for the learner nor do they provide any degree of feedback correction for mispronunciation or grammar.

More recently web based software programs have become available for teaching and learning foreign languages. The popularity of computer software and web based programs for teaching and learning foreign language has increased along with the proliferation of Internet (web) access and home computers. Computers have a significant advantage over traditional teaching aids since they have the ability to combine text, sound, and graphics that create an interactive learning experience. However, current software programs and web based systems are developed around pre-determined vocabulary lists and learning schedules or software modules that are designed to teach and develop literacy and fluency in a new language.

Despite the progress that has been made, there is still a need for the development of a web based, learning system that allows a learner to set their own schedule and learning pace by learning a language using content that is of interest to the learner, not pre-determined. Learners spending hours on isolated vocabulary lists do not develop the ability to use or understand this vocabulary in real-life situations. In contrast to the prior art discussed above, the present invention promotes the learning process by providing a language learning system based on increasing vocabulary in a way that is linked to familiar content and therefore can be used in everyday situations. The present invention is based on a system which continually measures and tracks a learner's vocabulary, phrases, and writing mistakes through study on the learner's own time and pace. It integrates the words and phrases learned with content chosen by the learner and written output created by the learner.

The present invention has the potential to accelerate language learning by implementing new techniques that reflect many of the most recent discoveries about how languages are acquired, while avoiding the disadvantages of the traditional didactic methods. The present invention is an integrated ,web based, computer system that relies on the well observed fact that language learning success depends on motivating and empowering the learner. The learner is asked to read and repetitively listen to authentic content. This is widely recognized to be an effective way to learn a new language if the learner can choose content that is familiar, interesting and at an appropriate level of complexity for the learner.

The present invention improves on the prior art by adding the previously mentioned learning components while allowing the learner to choose the content from a library of topics that are of interest to the learner. This is in stark contrast to the prior art which has content based on topics specifically designed for the language learner which are very often uninteresting and a chore to study. All language learners do not have the same interests or learning ability which is why this present invention's library provides authentic content on a wide range of subjects, at varying difficulty levels, that the learner can pick from. As well as web based discussions with native speaker coaches on a range of topics that the learner is free to suggest. In this way the learner can almost forget the he/she is studying a new language as they listen, read, or speak and really try to understand. The learning of proper syntax and vocabulary is facilitated by the integrated and unique features of the system, while the learner pursues subjects of interest.

### SUMMARY OF THE INVENTION

The present invention is an improved method of foreign language learning using a computer for providing web-based learning. The invention is a breakthrough in four important ways. First, it enables the learner to select authentic language content that is suited to the learner's vocabulary level, instead of having to rely on textbooks based on a pre-determined skill level and topic. Secondly, it combines context based vocabulary learning and the individual study of words and phrases through the use of a unique database. A third component links the recognition of phrases in language input (reading and listening) with phrases in language output (writing) and thereby bypasses the conventional teaching of grammar rules. This is reinforced by the use of measurement, which provides motivation for the learner and useful feedback to the teacher.

The emphasis on repetitive input of comprehensible material is a well known principle of language learning. However, this approach needs to go hand in hand with a systematic and effective way to acquire new vocabulary. The invention recognizes that the acquisition of vocabulary is the single most important process in developing language power. With a large enough vocabulary, the learner can even overcome problems of grammar or syntax and still communicate important concepts. Yet vocabulary acquisition is a complex process. The learner progresses from a passive ability to recognize one meaning of a new word, to a broader understanding of the meanings and nuances of a word, to a level of comfort at using a word, to a confidence in knowing what words are usually associated (collocated) with that word in expressions. This process requires frequent exposure through study and reading, and regular usage of the word in writing and speaking. The integration of listening, reading, tracking, coaching, talking, chatting with proper measurement in one system greatly improves the learner's ability to acquire the target language.

### BRIEF DESCRIPTION OF THE DRAWINGS

FIG. 1 illustrates the components of a web based language learning system;

FIG. 2 illustrates a block diagram of steps used to facilitate web based language learning;

FIG. 3 illustrates a typical control panel graphical user interface (GUI) according to an embodiment of the present invention;

FIG. 4 illustrates interactions of the word card feature according to an embodiment of the present invention;

FIG. 5 illustrates the databases and connectivity in a possible embodiment of the invention;

FIG. 6 illustrates a flow diagram of the writing correction feature of the language learning method;

FIG. 7 illustrates a typical graphical user interface (GUI) according to an embodiment of the present invention;

FIG. 8 illustrates the phrase card system.

### DETAILED DESCRIPTION OF THE INVENTION

Method of language learning in which the learner chooses content of interest for listening and reading, storage, and analysis of the learner's words and lexical phrases utilizing personalized databases through interaction with a web based computer system.

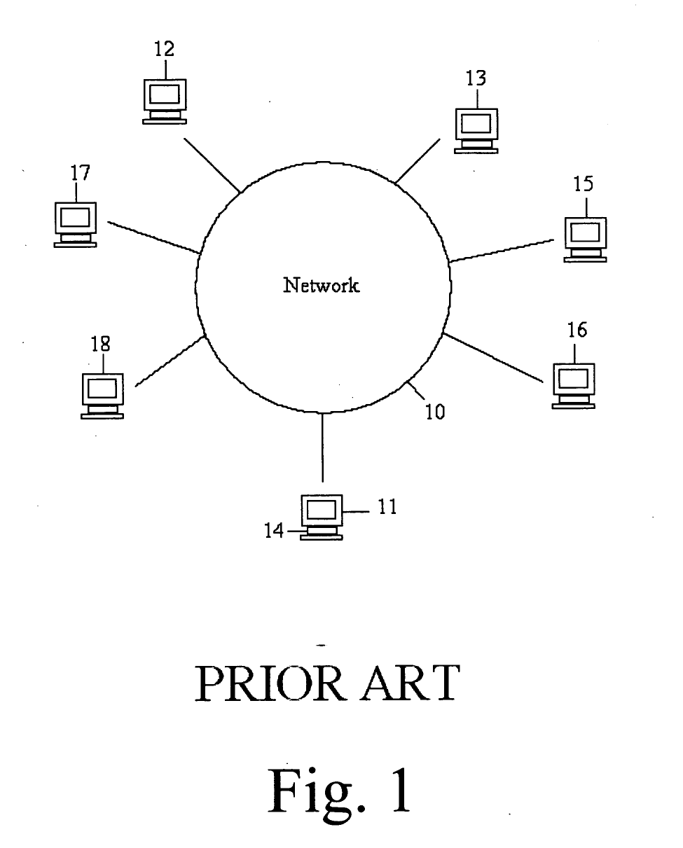

FIG. 1 shows a network of computers 10 that may be used to deliver the web based learning system and method. The network 10 includes a host system 11 that provides access to learner computers 12-13. Each learner computer includes a processor; memory; user input device such as microphone, keyboard, and/or mouse; output device such as a speaker, printer, and/or monitor. Leaner computers 12-13 are permitted to communicate with the host system 11 to obtain programs and data stored on the host system 11.

The host computer 11 includes one or more databases 14 for storing the language learning program and data. A large amount of data may be stored on the host computer 11 such as text, audio, video, graphics, animation, illustrations and a dictionary. A learner, while accessing the host computer 11 from a learner computer 12-13 may store information such as word lists, writing samples, and audio samples for review by language coaches. A language coach may access the host system 11 and databases 14 from a language coach computer 15-16 for such purposes as review, analysis, discussion and reading of learner's work. A language coach or learner may access the host computer 11 and databases 14 from any computer 17-18 connect to the Internet from any location.

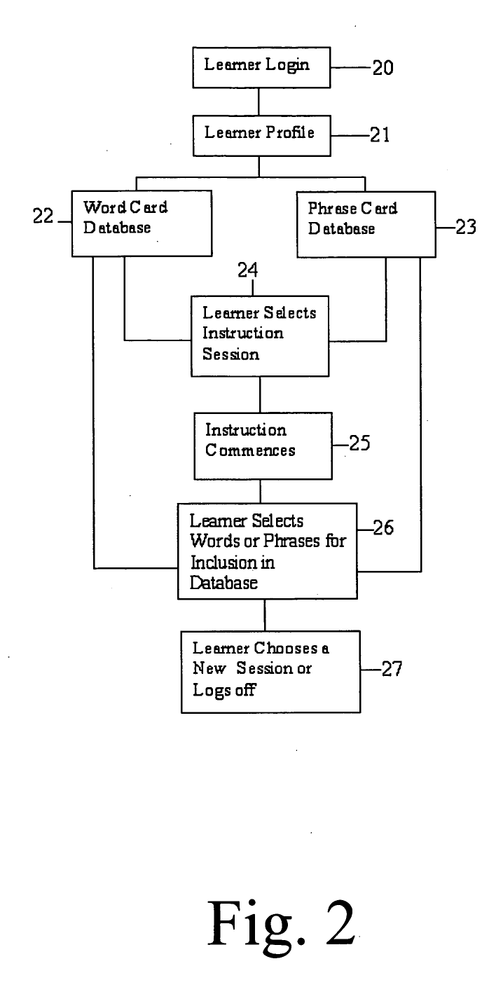

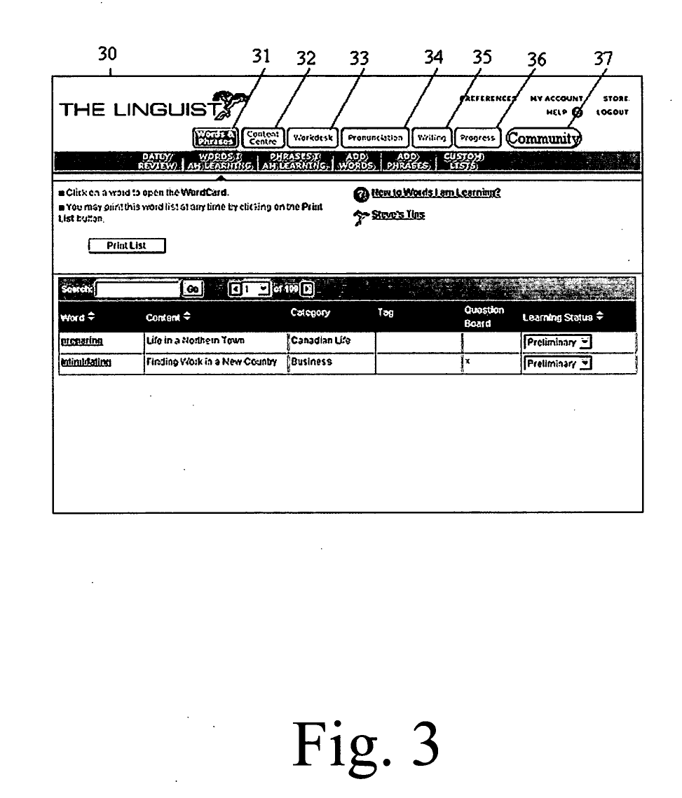

Referring now to FIG. 2, the method includes a learner login 20 through a web based program onto the host computer 11 to commence the learning experience. The host computer 11 accesses a learner profile 21 consisting of a word card database 22 and a phrase card database 23. Once learner login 20 is complete the web based system enables the user to select from a control panel 30, as depicted in FIG. 3, possessing a series of selectable instruction sessions that include: Word and Phrases 31, Content Center 32, Workdesk 33, Pronunciation 34, Writing 35, Progress 36 and Community 37. Learner selects an instructional session 24, instruction commences 25, the learner selects words or phrases for inclusion in the word card database 22 or phrase card database 23 as appropriate, learner then selects a new instructional session or logs off 27 host computer 11.

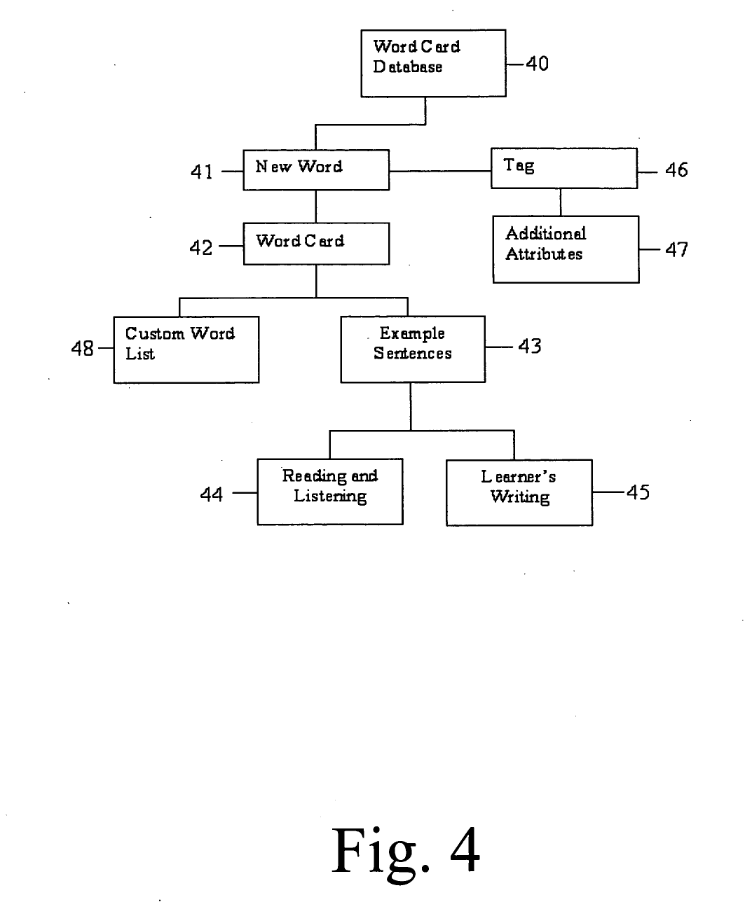

Referring to FIG. 4 the word and phrases 31 instructional session enables the learner to learn new words and phrases by systematically reading and hearing new word and phrases individually and in context. The invention creates a database of word cards 40 for each new word 41. Each word card 42 automatically collects example sentences 43 of the new word from contexts that the learner has encountered in reading and listening 44. The word card 42 also collects example sentences 43 of the correct use of the new word 41 from the learner's writing 45. The word card 42 automatically creates a subject category for the word.

The invention also allows the learner to create a tag 46 for the word to identify some other attribute 47 of the word that is useful to the learner. The learner can also control the frequency with which the word appears in a daily review of words that are being learned. This provides the learner with many different ways of reviewing words that are being studied such as, but not limited to, a daily review, review of sample sentences that originate in familiar content. Additionally, the user can chose to place the word card in a customized word lists 48 based on different attributes of the word, including its prefix, suffix or root word. The learner can then use these customized lists in language output (speaking and writing).

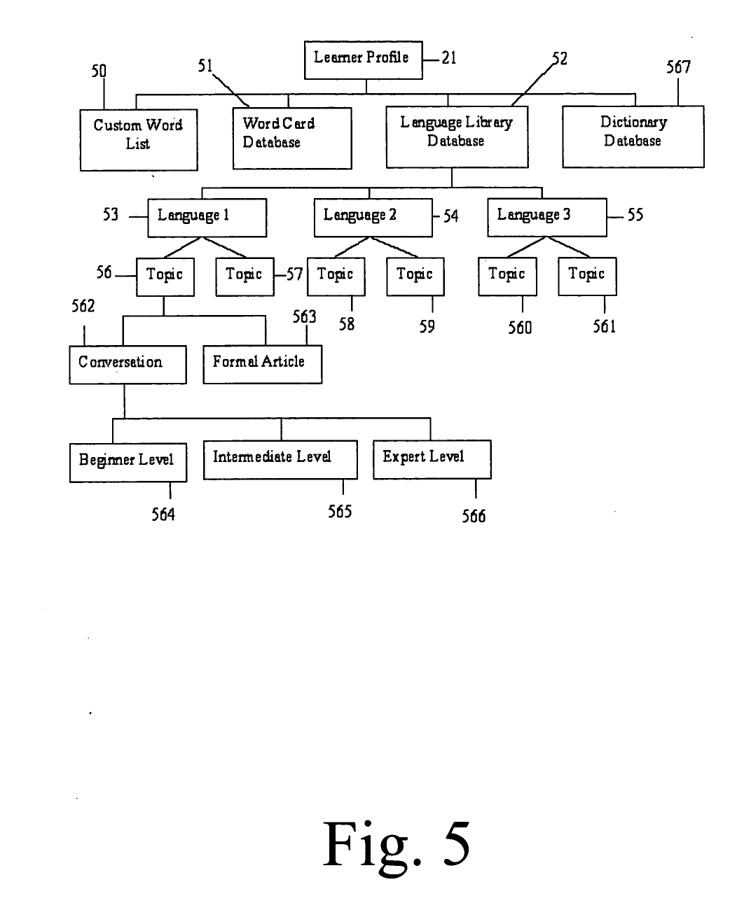

Referring to FIG. 5, there are a number of databases used in this learning method. A learner, after creating a user profile 21 the learner has access not only to their custom word list database 50, word card database 51, but to the content center instructional session which allows the learner to chose content from a language library database 52 that consists of a dictionary and many study topics since language is often best learned when a learn is interested in the study topics. The language library is stored in database format and contains of a dictionary 67 and a rage of topics 56-61 covering a range of languages 53-55. The language library contains interesting content covering a wide variety of topics that is produced in live conversation 62 between two native speakers or a more formal article 63. The content center also enables the learner to choose the right level of difficulty from a range of difficulty levels 64-66 found in the language library database 52.

The workdesk session provides a web-based platform where the learner can chose something of interest, listen to it, read it, and download it to their home computer. When the learner is in a workdesk session, it also provides the unique ability allow the learner to vary their reading by using the well known computer cut and paste method to insert or import outside content into the workdesk where the learner can then listen to it or read it at a later time and take advantage of the unique features of the system with this imported content.

The pronunciation session focuses the learner on problem words, sounds and sentence rhythm. In this session the learner will listen repeat and record their own voice for comparison with proper pronunciation and rhythm.

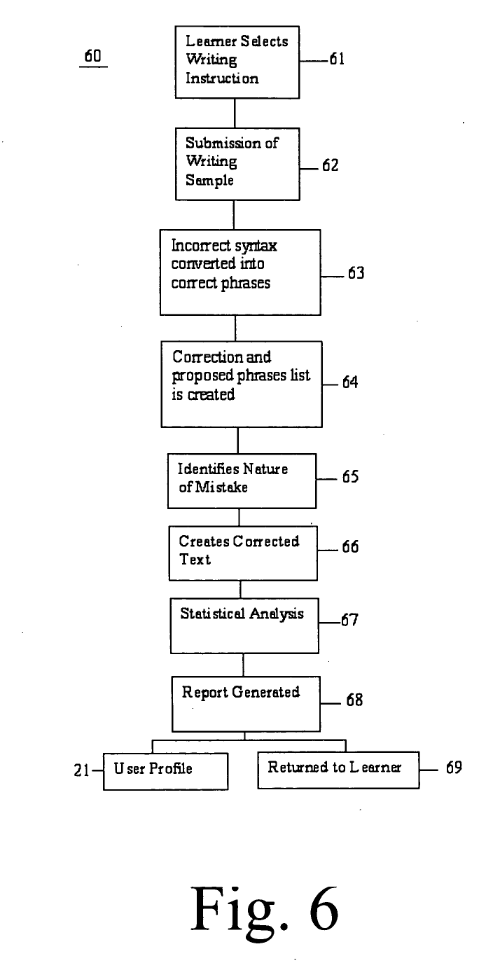

Now referring to FIG. 6 the present invention measures language output as well as language input through the writing instruction session 60 learner where learner first selects the writing instruction session 61 that allows the learner to use what they have learned by submitting their writing for correction 62. The present invention includes a unique writing corrector program which converts incorrect syntax into correct phrases 63, list the corrections and proposes correct phrases 64, identifies the nature of the mistake 65, creates a corrected version of the written text 66 to compare with the original, and develops an ongoing statistical analysis 67 of the kinds of errors made by the learner and the frequency of errors.

The writing sample and report 68 generated by the word corrector is then return to the learner 69 and stored in the learner profile 21. In this way the learner and the teacher can focus on the most frequent kind of syntactical errors and monitor his/her progress. The learner can also integrate the language output activity with the vocabulary acquisition and reading/listening activities of the program as both share the same database of words and phrases

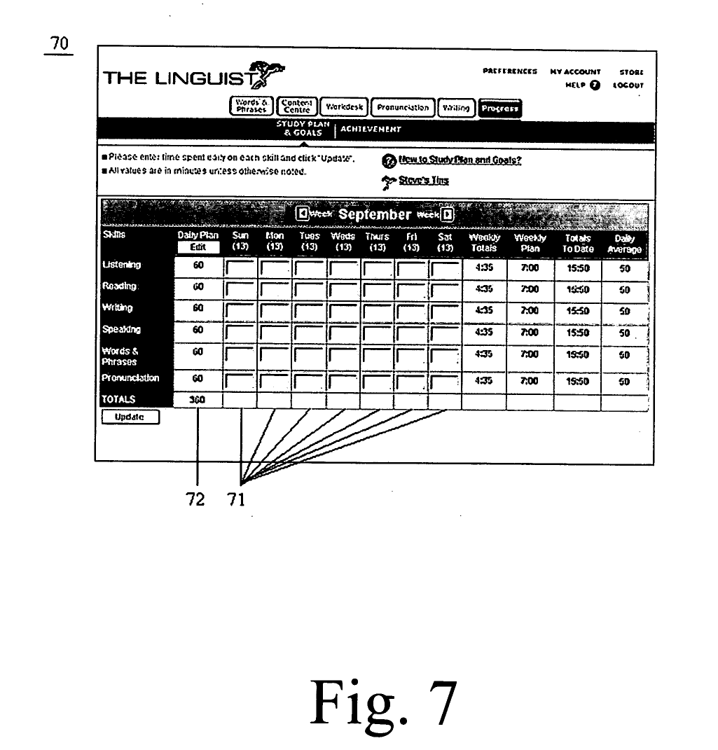

Now referring to FIG. 7, the progress instruction session 70 allows the learner to track their progress through a number of categories. The learner can track the time 71 they spend working on learning the new language, set goals 72, and design a daily plan of study. The database of word cards allows an ongoing measurement of words learned and words known. This database allows the learner to choose new content that is appropriate to his/her level. The measurement of words known and learned can be compared to the learner's own goals and to the record of other learners. The invention also measures how often the word has been encountered (passively learned) and used (actively learned) in writing. The learner's progress report is also stored in their learner profile 21 and can be shared with an optional online coach.

If the learner chooses to use a language teaching coach, the learning method provides the learner with a weekly one on one session with their coach over the web based system, writing correction and analysis by their coach and a weekly report created by the coach detailing and analyzing the learner's progress.

It is widely recognized that languages are learned more effectively in the form of blocks of words that naturally belong together in lexical phrases rather than by using the out-dated model of learning grammar and vocabulary as separate activities. The invention makes it possible for the learner to save useful phrases and create phrase cards in the same manner as the word cards described above.

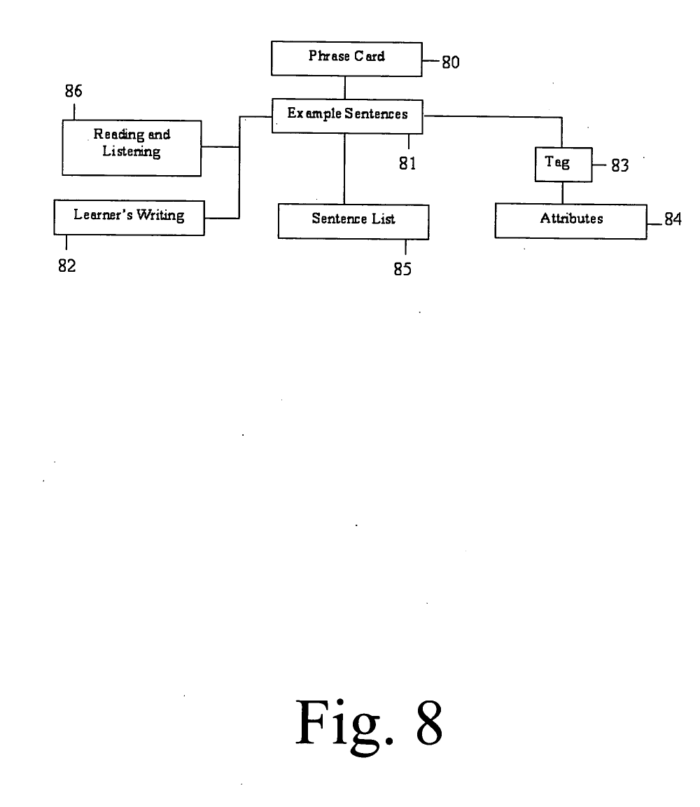

Now referring to FIG. 8 each phrase card 80 automatically collects example sentences 81 of the new phrase from contexts that the learner has encountered in reading and listening. The phrase card also collects example sentences of the correct use of the new phrase from the learner's writing 82. The phrase card automatically creates a subject category for the phrase. The invention also allows the learner to create a tag 83 for the phrase to identify some other attribute 84 of the phrase that is useful to the learner. The learner can also control the frequency with which the phrase appears in a daily review of phrases that are being learned. This provides the learner with many different ways of reviewing phrases that are being studied such as, but not limited to, the daily review, review of sample sentences that originate in familiar content.

The creation of customized lists 85 based on different attributes 84 of the phrase, including the component words that are collocated in the phrase. The learner can then use these customized lists 85 in language output (speaking and writing). The invention integrates all aspects of language learning. The web based community provides opportunities for learners to meet and communicate on subjects of interest, with coaches and with other learners.

In another embodiment learning system of the present invention is designed to help people learn from audio and digital text. The learning system of the present invention is effective in any learning situation where language is the main medium of instruction because the learning system of the present invention requires material to be presented in audio and digital text format. The learning system of the present invention requires that any material that can be presented in audio and digital format be used as study material.

The learning system of the present invention ties new concepts and information to context. It ensures that words and phrases are regularly reviewed while making it possible to remember without memorizing. As previously disclosed, users set their own goals and are able to monitor and analyze their written output. The learning system of the present invention measures learners' activities and progress towards their goals.

These and other features of the learning system of the present invention are effective in most learning situations where language rather than demonstration is the main medium of instruction.

The learning system of the present invention was originally designed for the purpose of foreign language development and incorporates the ability to listen to, read, and learn from the real language. Database technology allows for systematic review of new vocabulary until it is learned. Vocabulary database enables the displaying of examples tied to content from the learners own library of study material. Learner can maintain database of words and phrases and customize study lists of these words for review. Learner submits writing which is corrected and analyzed and returned with a statistical analysis. The whole learning process is accurately measured and statistics are kept. Learners' progress towards targets he has set is tracked and encouraged by system.

The learning system of the present invention enables learners in special needs education such as literacy programs, adult education, and other specifically for people with reading difficulties to hear and listen to meaningful content of their choice, and then methodically learn words and phrases from this content by using language learning engine of the present invention. This combination of listening, reading and word and phrase review increases retention and confidence. By systematically learning new words and phrases in context, not only are language skills improved, but the ability to understand new concepts is enhanced.

With respect to academic coursework such as high school courses, university and college courses (especially those in humanities), and vocational and technical courses, the subject of study is not the language itself, but course material of interest to learners and relevant to their studies. Using the language learning engine ensures that facts and concepts are more easily retained because they are learned in context. Users can receive course material, whether lectures, textbooks or supplementary course material, in audio and text format. Learners can listen again to lectures to improve comprehension. They can listen to audio recordings of their text material. They can read through lecture transcriptions or textbook material and identify, look up, and save key words, phrases, and concepts. These key words, phrases, concepts are then utilized in the review section which also draws in other examples using these terms from all course material in the system. In this way students can quickly view multiple examples from their reading incorporating the key points they are trying to learn.

Reinforcement from multiple sources speeds up and enhances the learning process. The student has the instant ability to test himself on all key points. This is a kind of electronic note-taking system, which can tie all notes together and present them for quick review. Once the student understands the concepts he can listen to the lectures again or to recorded text material to reinforce comprehension. The goal setting, testing and measurement features of the learning system of the present invention provide learners with an effective learning methodology and on going feedback.

Although the description above contains many specificities, they should not be construed as limiting the scope of the invention but as merely providing illustrations of some of the presently preferred embodiments of this invention. Thus, the scope of the invention should be determined by the appended claims and their legal equivalents, rather than by the examples given.

1. A computer-implemented method for providing language instruction comprising the steps of:
invoking a web browser; logging a learner computer into a host system to commence a learning session; and
creating a learner profile in a personal database; accessing a language library database; and
displaying to learner a control panel providing the learn with the option of choosing language instruction sessions; with the learner engaging in a selected instruction session; where the language is the main medium of instruction as said learning system requires material to be presented in audio and digital text format.

2. The method of claim 1 wherein material that is presented in audio and digital format may be used as study material.

3. The method of claim 1 wherein a learner may set their own goals and may monitor and analyze their written output.

4. The method of claim 1 wherein;
the language library contains a dictionary, recordings of live conversations, and written text in a variety of desired languages and skill levels;
the learner's personal database can be sorted and customized in a variety of ways to facilitate learning.

5. The method of claim 4 wherein said database allows for systematic review of new vocabulary until it is learned.

6. The method of claim 5 further comprising a vocabulary database which enables the displaying of examples tied to content from the learner's own library of study material.

7. The method of claim 6 wherein said learner can maintain a database of words and phrases and customize study lists of these words for review.

8. The method of claim 7 wherein a learner submits writing that is then corrected and analyzed and returned with a statistical analysis.

9. The method of claim 8 wherein a learners' progress towards targets said learner has set is tracked and encouraged by system.

10. The method of claim 1 wherein, with respect to academic, vocational, and technical courses, the subject of study is not the language itself, but course material of interest to learners and relevant to their studies.

11. The method of language learning of claim 1 wherein learners can receive course material, whether lectures, textbooks or supplementary course material, in audio and text format.

12. The language learning method of claim 11 wherein said learners can listen again to lectures previously recorded to improve comprehension.

13. The language learning method of claim 12 wherein learners can listen to audio recordings of their text material.

14. The language learning method of claim 13 wherein a learner can read through lecture transcriptions or textbook material and identify, look up, and save key words, phrases, and concepts in a computerized database; said key words, phrases, concepts are then utilized in a review section which also draws in other examples using these terms from all course material in the system enabling a learner to quickly view multiple examples from their reading incorporating the key points they are trying to learn.

15. The language learning method of claim 14 further comprising an electronic note-taking system the enables a learner to self test on key points, said electronic note-taking system compiling all notes and them presenting them in a format for quick review.

16. The language learning method of claim 1 further comprising goal setting, testing and measurement features which provides learners with an effective learning methodology and on going feedback.
